(19) United States
(12) Patent Application Publication
(10) Pub. No.: US 2019/0061352 A1
(43) Pub. Date: Feb. 28, 2019

(54) PRINTHEAD CAPPER

(71) Applicant: Memjet Technology Limited, Dublin (IE)

(72) Inventors: Geordie McBain, North Ryde (AU); Samuel Mallinson, North Ryde (AU); Brian Brown, North Ryde (AU)

(21) Appl. No.: 16/110,583

(22) Filed: Aug. 23, 2018

Related U.S. Application Data
(60) Provisional application No. 62/549,384, filed on Aug. 23, 2017.

(51) Int. Cl. B41J 2/165; B41J 2/175

(52) U.S. Cl. CPC B41J 2/16505; B41J 2/1752; B41J 2/16585

(57) ABSTRACT

A capper for an inkjet printhead has a perimeter seal for sealing engagement with a capping surface of the printhead. The perimeter seal is formed from an auxetic material having a negative Poisson's ratio. The capper is suitable for capping printheads having capping surfaces containing non-unformities. The capper is especially suitable for capping pagewide inkjet printheads.

### CROSS-REFERENCE TO RELATED APPLICATIONS

This application claims priority to and the benefit of U.S. Provisional Patent Application No. 62/549,384 entitled PRINTHEAD CAPPER, filed Aug. 23, 2017, the disclosure of which is incorporated herein by reference in its entirety.

### FIELD OF THE INVENTION

This invention relates to a capper for a printhead. It has been developed primarily to improve sealing around an inkjet printhead and for minimizing vapor losses.

### BACKGROUND OF THE INVENTION

The Applicant has developed a range of Memjet® inkjet printers as described in, for example, WO2011/143700, WO2011/143699 and WO2009/089567, the contents of which are herein incorporated by reference. Memjet® printers employ one or more stationary inkjet printheads in combination with a feed mechanism which feeds print media past the printhead in a single pass. Memjet® printers therefore provide much higher printing speeds than conventional scanning inkjet printers.

All inkjet printheads need to be capped during non-printing periods to prevent nozzles from drying out. Typically, a printhead capper comprises a compliant perimeter seal engaged with a capping surface of the printhead so as to provide a sealed humid environment for the nozzles. Nevertheless, some drying of the nozzles is inevitable and printers typically perform remedial maintenance operations after uncapping to ensure that the printhead is ready to print. For example, a forced positive pressure prime may be used to unblock any blocked nozzles (see, for example, U.S. Pat. No. 8,845,083, the contents of which are herein incorporated by reference). Additionally or alternatively, the printhead nozzles may eject ink into a spittoon to ensure each nozzle is hydrated and primed with ink.

It is desirable to maximize the humidity of the nozzle environment when a printhead is capped. In this way, the remedial measures required for full nozzle health after uncapping can be minimized. Minimizing such remedial measures not only shortens the ‘wake-up’ time of the printer, but also reduces the amount of ink consumed for non-printing purposes during spitting and pressure priming.

Capping surfaces of printheads are typically non-uniform and contain imperfections, such as cracks, steps and bumps. These features result in imperfect sealing when the compliant perimeter seal of a capper is pressed against the capping surface of the printhead. Imperfect sealing is particularly exacerbated in pagewide printheads where the perimeter seal is required to seal against a relative long capping surface.

It would therefore be desirable to improve the sealing between a capper and a printhead so as to minimize vapor losses during printhead capping.

### SUMMARY OF THE INVENTION

In a first aspect, there is provided a capper for an inkjet printhead, the capper having a perimeter seal for sealing engagement with a capping surface of the printhead, wherein the perimeter seal is comprised of an auxetic material.

Preferably, the capper comprises a rigid capping chamber having a perimeter lip surrounding a mouth of the chamber, the perimeter seal being bonded to the perimeter lip.

Preferably, the auxetic material is a closed-cell foam.

Preferably, the perimeter seal is comprised of an auxetic polyurethane or an auxetic polytetrafluoroethylene polymer.

In a second aspect, there is provided a printer comprising:
an inkjet printhead having a capping surface; and
a capper having a perimeter seal for sealing engagement with the capping surface of the printhead,
   wherein the perimeter seal is comprised of an auxetic material.

Preferably, the capping surface is non-uniform.

Preferably, the printhead has a length of at least 4 inches, at least 5 inches or at least 8 inches.

In some embodiments, the printhead is a pagewide inkjet printhead.

As used herein, the term “printer” refers to any printing device for marking print media, such as conventional desktop printers, label printers, duplicators, copiers, digital inkjet presses and the like.

### BRIEF DESCRIPTION OF THE DRAWINGS

Embodiments of the present invention will now be described by way of example only with reference to the accompanying drawings, in which:

FIG. 1 is a top perspective view of a capper;

FIG. 2 is a sectional perspective of the capper shown in FIG. 1; and

FIG. 3 is a perspective of a pagewide printhead.

### DETAILED DESCRIPTION OF THE INVENTION

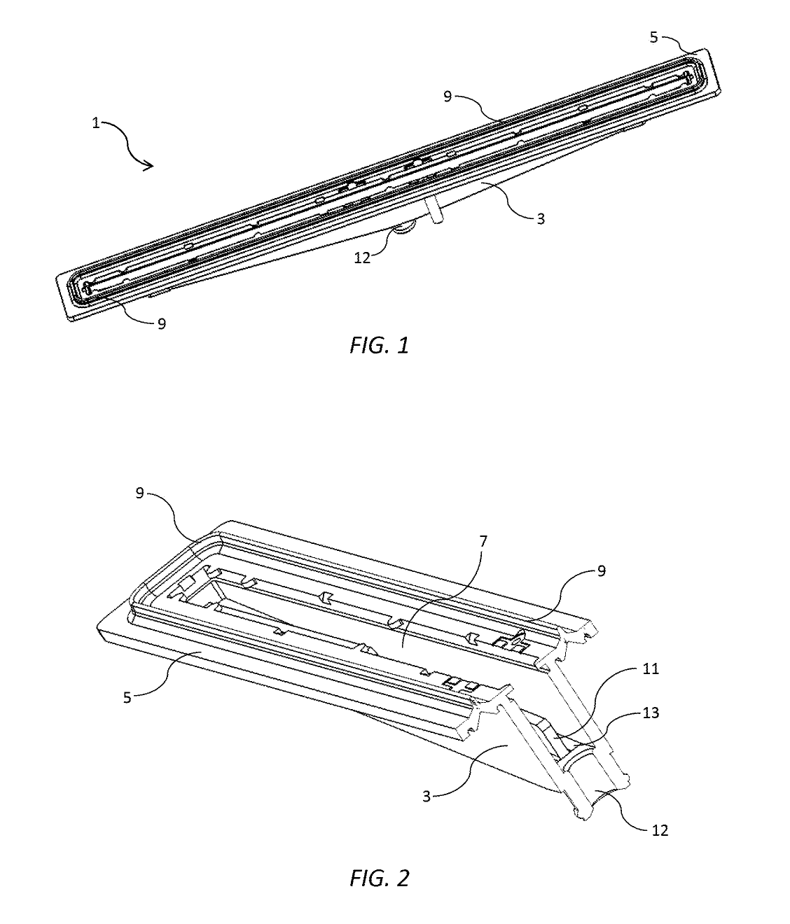

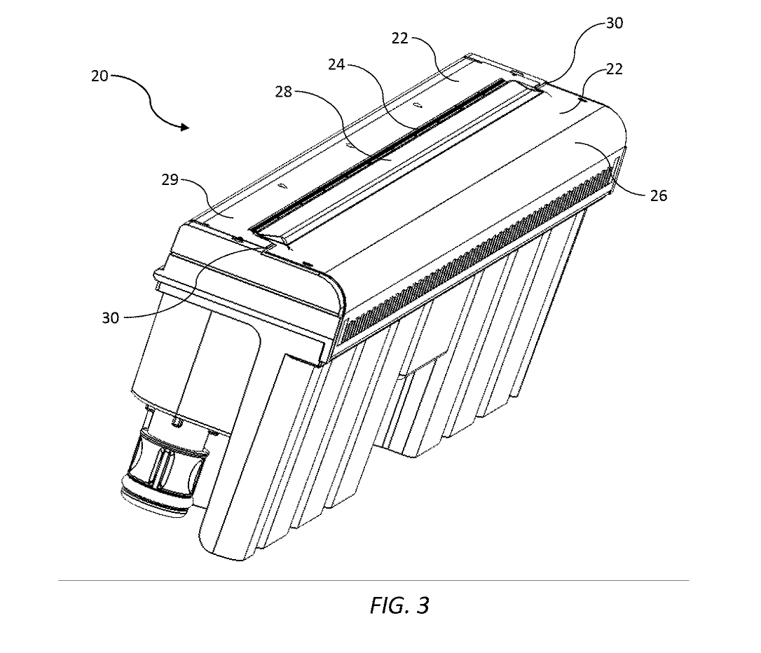

Referring to FIGS. 1 and 2, there is shown a capper 1 for capping a pagewide printhead. The capper 1 comprises a rigid capping chamber 3 having a perimeter lip 5 surrounding a mouth 7 of the chamber. A perimeter seal 9 is fixed to the perimeter lip 5 of the capping chamber 3 for engagement with a capping surface 22 of a printhead 20 (FIG. 3), as is well known in the art.

As shown in FIG. 2, the capping chamber 3 is generally elongate and has an elongate strip of an absorbent material 11 attached to a floor 13 of the chamber. In use, the absorbent material 11 may act as a spittoon by receiving ink droplets ejected from the printhead 20. Ink retained by the absorbent material 11 assists in maintaining a humid environment within the capping chamber 3 when the printhead is capped. Excess ink within the capping chamber 3 may be drained, either using gravity or a suitable pump, via a drainage port 12 extending from the floor 13 of the capping chamber. A valve (not shown) controls opening and closing of the drainage port 12, such that the port is usually closed during capping periods.

The perimeter seal 9 is formed of an auxetic material, such as an auxetic polyurethane foam or an auxetic polytetrafluoroethylene polymer. Auxetics are structures or materials that have a negative Poisson's ratio, as will be appreciated by the person skilled in the art. When stretched, auxetic materials become thicker perpendicular to the applied force. This occurs due to their particular internal structure and the way in which this internal structure deforms when the material is uniaxially loaded.

The perimeter seal 9 formed of an auxetic material is, therefore, well suited to form a seal over a non-uniform capping surface of a printhead. FIG. 3 shows a printhead 20 having a row of butting printhead chips 24. The printhead chips 24 receive power and data from a flex PCB 26 via wirebonds (not shown), covered by an encapsulant. The printhead chips 24 are themselves mounted on a die-attach film 29, which delivers ink to the backside surfaces of the printhead chips. The capping surface 22 of the printhead 20 is defined by portions of the flex PCB 26 and the die-attach film 29. The capping surface 22 has non-uniformities 30 in the form of a small step and a gap at each end of the printhead 20 where the flex PCB 26 meets the die-attach film 29.

Since the perimeter seal 9 is formed of an auxetic material, it is better able to conform to the non-uniformities 30 in the capping surface 22 than, for example, a conventional elastomer. In particular, the force of urging the capper 1 against the capping surface 22 tends to deform the perimeter seal 9 in such a way as to seal against any the non-uniformities 30. In this way, the seal between the printhead 20 and the capper 1 is improved compared to conventional cappers, thereby reducing vapor losses during capped periods.

It will, of course, be appreciated that the present invention has been described by way of example only and that modifications of detail may be made within the scope of the invention, which is defined in the accompanying claims.

1. A capper for an inkjet printhead, the capper having a perimeter seal for sealing engagement with a capping surface of the printhead, wherein the perimeter seal is comprised of an auxetic material.

2. The capper of claim 1, wherein the capper comprises a rigid capping chamber having a perimeter lip surrounding a mouth of the chamber, the perimeter seal being bonded to the perimeter lip.

3. The capper of claim 1, wherein the auxetic material is a closed-cell foam.

4. The capping assembly of claim 1, wherein the perimeter seal is comprised of an auxetic polyurethane or an auxetic polytetrafluoroethylene polymer.

5. A printer comprising:
an inkjet printhead having a capping surface; and
a capper having a perimeter seal for sealing engagement with the capping surface of the printhead,
wherein the perimeter seal is comprised of an auxetic material.

6. The printer of claim 5, wherein the capping surface is non-uniform.

7. The printer of claim 4, wherein the auxetic material is a closed-cell foam.

8. The printer of claim 5, wherein the perimeter seal is comprised of an auxetic polyurethane or auxetic polytetrafluoroethylene polymer.

9. The printer of claim 5, wherein the printhead has a length of at least 4 inches.

10. The printer of claim 5, wherein the printhead is a pagewide inkjet printhead.
